(19) United States
(12) Patent Application Publication
(10) Pub. No.: US 2008/0138040 A1
(43) Pub. Date: Jun. 12, 2008

(54) IMAGING DEVICE, SETTING METHOD, AND PROGRAM

(75) Inventor: Junichi IEDA, Aichi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: Sony Corporation, Tokyo (JP)

(21) Appl. No.: 11/867,453

(22) Filed: Oct. 4, 2007

(30) Foreign Application Priority Data
Dec. 7, 2006 (JP) 2006-330817

(51) Int. Cl. H04N 5/00

(52) U.S. Cl. 386/117

(57) ABSTRACT

An imaging device has at least an imaging function and a playback function of playing back captured video signals. The imaging device includes a display controller configured to detect occurrence of a problem relating to the imaging function or the playback function, and to display a button together with a message indicating a kind of the problem when the problem detected is a problem solvable by changing setting, the button being a button that is operated when changing setting to solve the problem; and a setting unit configured to change setting according to an operation of the button displayed by the display controller.

### CROSS REFERENCES TO RELATED APPLICATIONS

The present invention contains subject matter related to Japanese Patent Application JP 2006-330817 filed in the Japanese Patent Office on Dec. 7, 2006, the entire contents of which are incorporated herein by reference.

### BACKGROUND OF THE INVENTION

1. Field of the Invention

The present invention relates to imaging devices, setting methods, and programs. More specifically, the present invention relates to an imaging device, a setting method, and a program with which a user can readily and quickly change setting to solve a problem relating to an imaging function or a playback function of playing back captured video signals.

2. Description of the Related Art

Imaging devices such as video cameras are being improved in recent years so that users can enjoy clearer video content with higher image qualities. In accordance with this trend, functions that serve to improve image qualities of video content and functions that allow user to enjoy imaging are being enriched.

In order to deal with existence of a plurality of formats due to the emergence of high definition video content, such as 1080i and 1920i, and difference among recording media, such as tapes, digital versatile discs (DVDs), and hard discs, the number of functions whose setting can be changed are increasing in imaging devices, so that setting tends to be complex.

Japanese Unexamined Patent Application Publication No. 63-229415 discloses techniques for automatically detecting inappropriate focus and displaying an alert message.

### SUMMARY OF THE INVENTION

The enrichment of functions described above is desirable for users who wish to enjoy clearer video content and more effective imaging.

However, users who are not used to such imaging devices might not be able to guess functions from function names without viewing user's manuals, to find an intended function from a large number of functions in a menu screen, or to turn off a certain function in accordance with a situation after turning on the function.

Thus, for example, a problem that video content is not displayed appropriately even when captured video signals are played back occurs due to inappropriate setting.

In such a situation, it has been the case to attempt to solve the problem by displaying a message upon detection of occurrence of the problem. That is, by displaying the message, the user is notified of a kind of the problem, the name of a function for solving the problem, and a method of setting of the function, so that the user is prompted to change setting.

However, in some cases, it is difficult to open a setting screen for solving the problem from a menu screen or the like, so that the problem remains unsolved.

Furthermore, even a user who has got use to operation of imaging devices has to perform a laborious operation using buttons a plurality of times to open a setting screen.

Now, specific examples of displayed screens will be described with reference to FIGS. 1 to 6.

FIGS. 1 to 6 are diagrams showing examples of screens displayed on a video camera.

It is assumed herein that the video camera is capable of recording video signals in a standard definition (SD) format and video signals in a high definition (HD) format together on the same tape and playing back these video signals.

More specifically, for example, a user can record a certain scene in the SD format and record another scene in the HD format. The user can select a format at the time of imaging using a setting screen that can be opened from a menu screen. It is also assumed herein that the video camera is also capable of writing video signals in the HD format over a tape having recorded video signals captured by an imaging device that is only capable of imaging in the SD format.

When playing back captured video signals, the user can select a format of video signals to be played back (playback format) so that only video signals in a specific format are played back.

FIG. 1 is a diagram showing an example of a setting screen used to select a playback format.

In an upper part of the setting screen, “Video HDV/DV” is displayed, indicating that the setting screen shown in FIG. 1 is displayed when a function having the name “Video HDV/DV” is selected in a menu screen. The user can select “Auto” by pressing a button 1 displayed in the setting screen, select “HD” (HDV) by pressing a button 2, and select “SD” (DV) by pressing a button 3.

On a liquid crystal display (LCD) panel of the video camera, a touch panel is displayed. The user can operate the touch panel by directly pressing buttons on the screen with a finger.

“Auto” is a setting with which the video camera automatically switches playback processing in accordance with the format of video signals to be played back. “SD” is a setting with which only video signals in the SD format are played back. “HD” is a setting with which only video signals in the HD format are played back.

When the user has selected “HD” by pressing the button 2 in the setting screen shown in FIG. 1, video signals recorded in the SD format are not played back. That is, while a segment of video signals recorded in the SD format are being played back, video content that is played back is displayed, so that a blue background is displayed on the screen.

Thus, although this is not a problem if the user has selected “HD” intentionally, if the user has selected “HD” by mistake, the user does not understand why video content is not displayed.

Thus, a popup 11 is displayed as shown in FIG. 2, in which a message saying “It is not allowed to display this signal under the “Video HDV/DV” setting. Please change setting to display this signal.” is displayed, so that the user is prompted to change setting. In the popup 11, a closing button 11A that is operated when closing the displayed message is also displayed. The plain region serving as a background of the popup and so forth shown in FIG. 2 is displayed in blue.

In order to change setting according to the message, the user has to first press the closing button 11A to close the popup 11 as shown in FIG. 3, and then press a button 25 among buttons 21 to 25 displayed in a lower part of the screen to open a menu screen shown in FIG. 4. The button 25 shown in FIG. 3 is a button that is operated when opening the menu screen.

Furthermore, the user has to find the function of “Video HDV/DV” by pressing a scroll button 31 or 32 in the menu screen. A function that is currently chosen, “Picture applications” in the state shown in FIG. 4, is displayed at the center of the menu screen.

When the function of “Video HDV/DV” has been chosen as shown in FIG. 5 by pressing the scroll button 31 or 32, the user presses an OK button 33 or a function selecting button 34 showing text “Video HDV/DV” to display the setting screen for “Video HDV/DV” shown in FIG. 1.

When “Auto” or “SD” has been selected in the setting screen shown in FIG. 1 to change setting appropriately, playback of video signals in the SD format is started, so that video content that is played back is displayed on the screen, as shown in FIG. 6.

As described above, a large number of operation steps has to be taken simply to select a playback format. This has been a difficult task for novice users.

It is desired that a user can readily and quickly change setting to solve a problem relating to an imaging function or a playback function of playing back captured video signals.

According to a first embodiment of the present invention, there is provided an imaging device at least having an imaging function and a playback function of playing back captured video signals, the imaging device including display controlling means for detecting occurrence of a problem relating to the imaging function or the playback function, and displaying a button together with a message indicating a kind of the problem when the problem detected is a problem solvable by changing setting, the button being a button that is operated when changing setting to solve the problem; and setting means for changing setting according to an operation of the button displayed by the display controlling means.

The display controlling means may display the message as superposed on a screen exhibiting occurrence of the problem.

The display controlling means may further display a message indicating an operation for solving the problem.

Furthermore, according to the first embodiment of the present invention, there is provided a setting method or program for an imaging device at least having an imaging function and a playback function of playing back captured video signals, the setting method or program including the steps of detecting occurrence of a problem relating to the imaging function or the playback function, and displaying a button together with a message indicating a kind of the problem when the problem detected is a problem solvable by changing setting, the button being a button that is operated when changing setting to solve the problem; and changing setting according to an operation of the displayed button.

According to a second embodiment of the present invention, there is provided an imaging device at least having an imaging function and a playback function of playing back captured video signals, the imaging device including display controlling means for detecting occurrence of a problem relating to the imaging function or the playback function, displaying a button together with a message indicating a kind of the problem when the problem detected is a problem solvable by changing setting, the button being a button that is operated when displaying a setting screen used for changing setting, and displaying the setting screen in response to an operation of the button in place of a screen displaying the message; and setting means for changing setting according to an operation performed using the setting screen displayed by the display controlling means.

Furthermore, according to the second embodiment of the present invention, there is provided a setting method or program for an imaging device at least having an imaging function and a playback function of playing back captured video signals, the setting method or program including the steps of detecting occurrence of a problem relating to the imaging function or the playback function, displaying a button together with a message indicating a kind of the problem when the problem detected is a problem solvable by changing setting, the button being a button that is operated when displaying a setting screen used for changing setting, and displaying the setting screen in response to an operation of the button in place of a screen displaying the message; and changing setting according to an operation performed using the displayed setting screen.

According to the first embodiment of the present invention, occurrence of a problem relating to the imaging function or the playback function is detected, and a button is displayed together with a message indicating a kind of the problem when the problem detected is a problem solvable by changing setting, the button being a button that is operated when changing setting to solve the problem. Furthermore, setting is changed according to an operation of the displayed button.

According to the second embodiment of the present invention, occurrence of a problem relating to the imaging function or the playback function is detected, a button is displayed together with a message indicating a kind of the problem when the problem detected is a problem solvable by changing setting, the button being a button that is operated when displaying a setting screen used for changing setting, and the setting screen is displayed in response to an operation of the button in place of a screen displaying the message. Furthermore, setting is changed according to an operation performed using the displayed setting screen.

According to these embodiments of the present invention, a user can readily and quickly change setting to solve a problem relating to an imaging function or a playback function of playing back captured video signals.

### BRIEF DESCRIPTION OF THE DRAWINGS

FIG. 1 is a diagram showing an example of a screen displayed on a video camera;

FIG. 2 is a diagram showing another example of a screen displayed on a video camera;

FIG. 3 is a diagram showing yet another example of a screen displayed on a video camera;

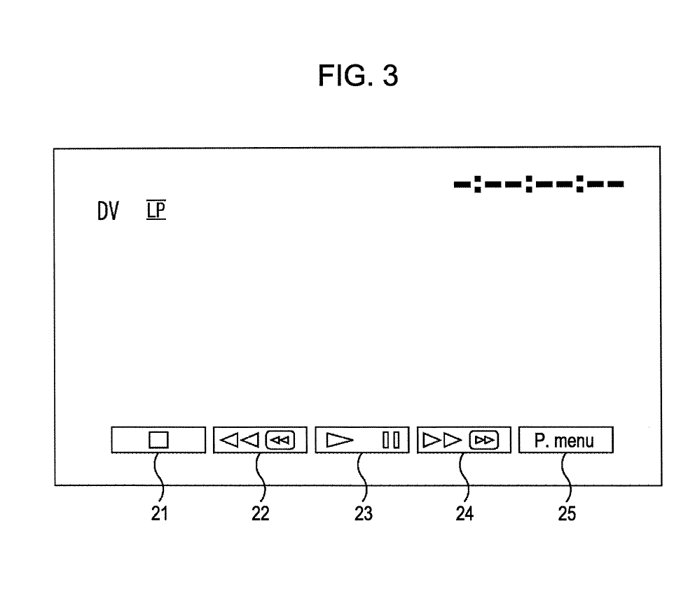

FIG. 4 is a diagram showing an example of a screen displayed on a video camera;

FIG. 5 is a diagram showing another example of a screen displayed on a video camera;

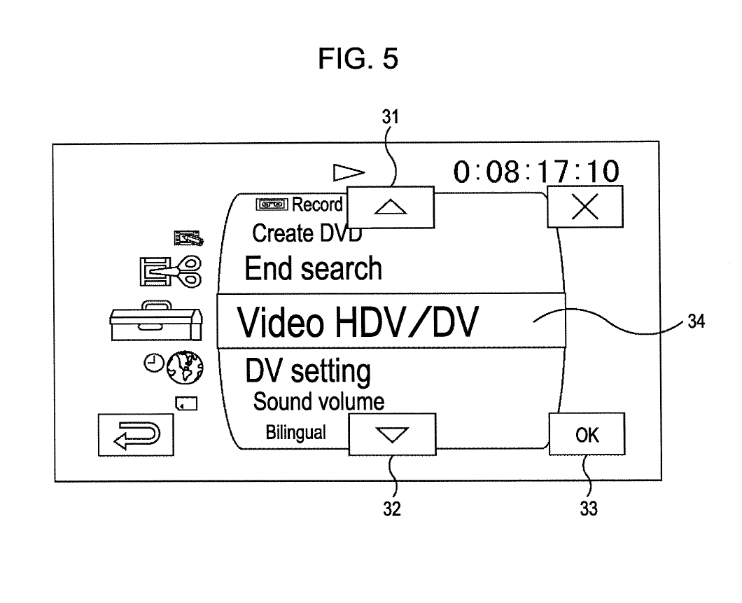

FIG. 6 is a diagram showing yet another example of a screen displayed on a video camera;

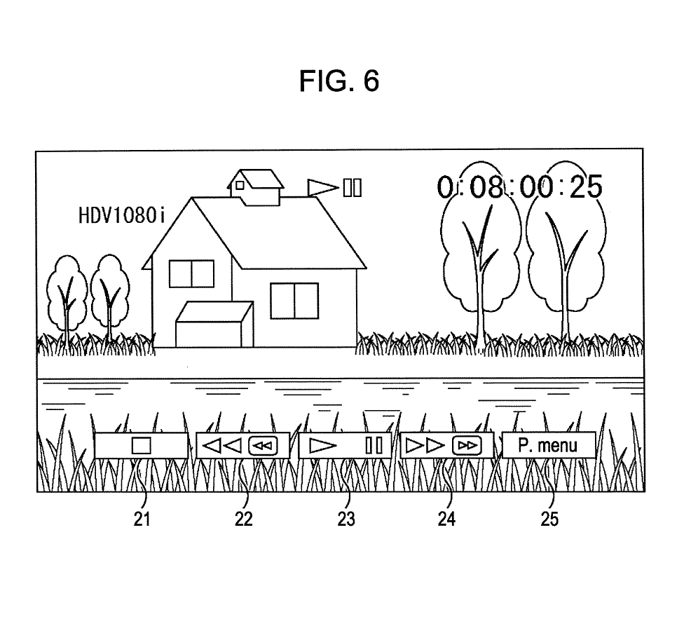

FIG. 7 is a block diagram showing an example hardware configuration of a video camera according to an embodiment of the present invention;

FIG. 8 is a block diagram showing an example functional configuration of the video camera;

FIG. 9 is a flowchart of a process executed by the video camera;

FIG. 10 is a diagram showing an example of a screen displayed on the video camera;

FIG. 11 is a diagram showing an example of a screen displayed on the video camera subsequently to the screen shown in FIG. 10;

FIG. 12 is a diagram showing an example of a screen displayed on the video camera subsequently to the screen shown in FIG. 11;

FIG. 13 is a diagram showing an example of a screen displayed on the video camera;

FIG. 14 is a diagram showing an example of a screen displayed on the video camera subsequently to the screen shown in FIG. 13;

FIG. 15 is a diagram showing an example of a screen displayed on the video camera subsequently to the screen shown in FIG. 14;

FIG. 16 is a diagram showing an example of a screen displayed on the video camera subsequently to the screen shown in FIG. 15; and

FIG. 17 is a diagram showing an example of a screen displayed on the video camera subsequently to the screen shown in FIG. 16.

### DESCRIPTION OF THE PREFERRED EMBODIMENTS

Before describing embodiments of the present invention, examples of correspondence between the features of the present invention and embodiments described in the specification or shown in the drawings will be described below. This description is intended to assure that embodiments supporting the present invention are described in this specification or shown in the drawings. Thus, even if a certain embodiment is not described in this specification or shown in the drawings as corresponding to certain features of the present invention, that does not necessarily mean that the embodiment does not correspond to those features. Conversely, even if an embodiment is described or shown as corresponding to certain features, that does not necessarily mean that the embodiment does not correspond to other features.

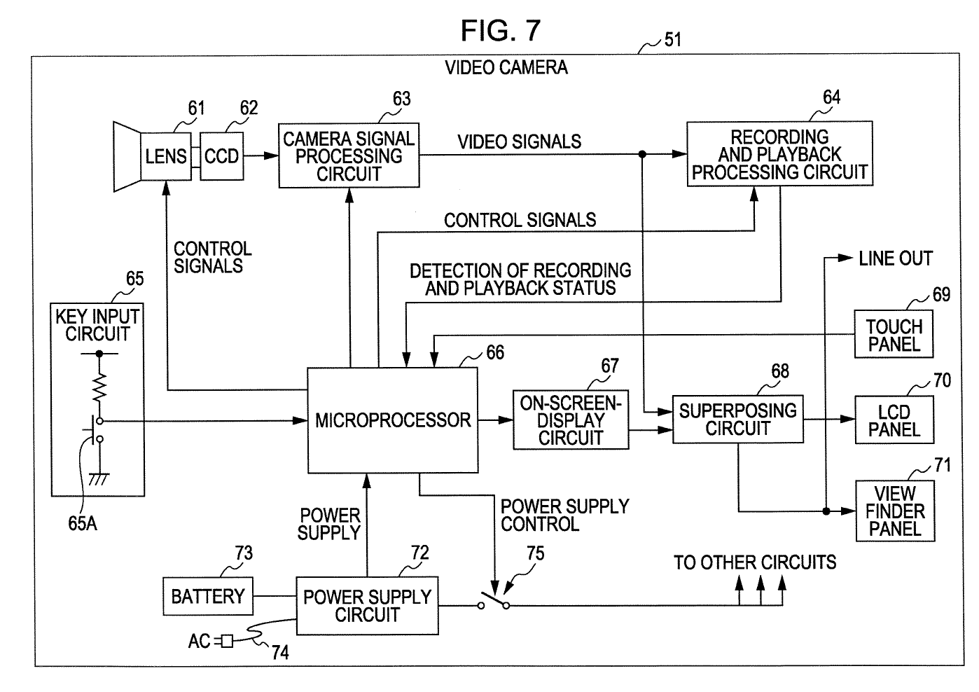

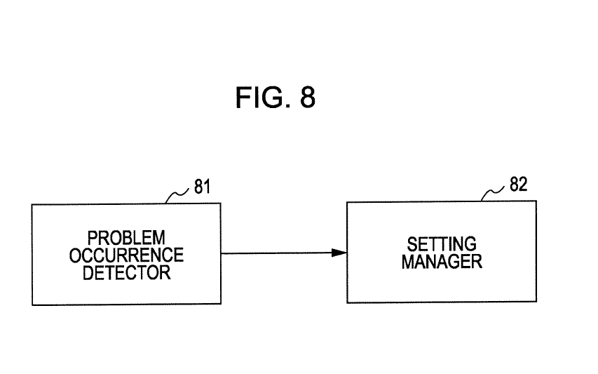

An imaging device (e.g., a video camera 51 shown in FIG. 7) according to a first embodiment of the present invention is an imaging device at least having an imaging function and a playback function of playing back captured video signals, the imaging device including display controlling means (e.g., a problem occurrence detector 81 shown in FIG. 8) for detecting occurrence of a problem relating to the imaging function or the playback function, and displaying a button together with a message indicating a kind of the problem when the problem detected is a problem solvable by changing setting, the button being a button that is operated when changing setting to solve the problem; and setting means (e.g., a setting manager 82 shown in FIG. 8) for changing setting according to an operation of the button displayed by the display controlling means.

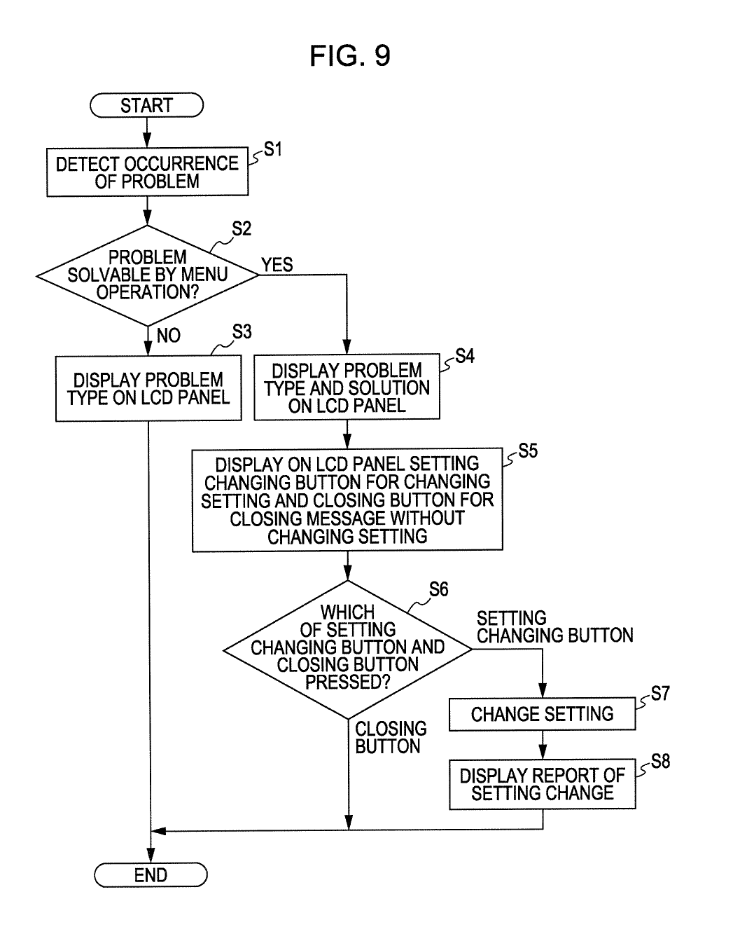

A setting method or program according to a first embodiment of the present invention is a method or program for an imaging device at least having an imaging function and a playback function of playing back captured video signals, the setting method or program including the steps (e.g., step S7 shown in FIG. 9) of detecting occurrence of a problem relating to the imaging function or the playback function, and displaying a button together with a message indicating a kind of the problem when the problem detected is a problem solvable by changing setting, the button being a button that is operated when changing setting to solve the problem; and changing setting according to an operation of the displayed button.

Now, embodiments of the present invention will be described with reference to the drawings.

FIG. 7 is a block diagram showing an example of the hardware configuration of a video camera 51 according to an embodiment of the present invention.

The video camera 51 has an imaging function, and a playback function for playing back captured video signals. When any problem relating to the imaging function occurs during imaging, such as a failure to execute imaging with an appropriate image quality, or any problem relating to the playback function occurs during playback of captured video signals, such as a failure to display video content that is played back, if the problem can be solved by changing setting, the video camera 51 presents a user with a message indicating a kind of the problem and an operation for solving the problem.

On the screen showing the message, a shortcut button that is operated when changing setting directly to solve the problem is also displayed, so that the user can readily and quickly change the setting causing the problem by pressing the shortcut button. When the setting has been changed and the problem has been solved by pressing the shortcut button, imaging with an appropriate image quality, display of video content that is played back, or the like is started.

A lens 61 changes an aperture value to adjust brightness according to a control signal supplied from a microprocessor 66, and sends collected external light to a charge coupled device (CCD) 62.

The CCD 62 performs photoelectric conversion of light input via the lens 61 to generate analog electric signals, and outputs the electric signals to a camera signal processing circuit 63.

Under the control of the microprocessor 66, the camera signal processing circuit 63 converts the electric signals supplied from the CCD 62 into digital video signals, and executes processing for adding certain video effects to the video signals, such as white balance adjustment and resolution conversion.

For example, the video camera 51 is capable of recording captured video signals as video signals in the SD format or video signals in the HD format. That is, video effects are added in the camera signal processing circuit 63 so that the video signals are recorded in a format selected by the user. The camera signal processing circuit 63 outputs video signals with the added video effects to a recording and playback processing circuit 64 and a superposing circuit 68.

The recording and playback processing circuit 64 records the video signals supplied from the camera signal processing circuit 63 on a recording medium (not shown) according to a control signal supplied from the microprocessor 66. For example, a tape is used as the recording medium.

Furthermore, upon receiving from the microprocessor 66 an instruction for playing back video signals recorded on the recording medium, the recording and playback processing circuit 64 reads data from the recording medium, and outputs video signals obtained by playing back the data to the superposing circuit 68. The recording and playback processing circuit 64 notifies the microprocessor 66 of a status of recording during recording of video signals, and notifies the microprocessor 66 of a status of playback during playback of video signals.

A key input circuit 65 has a special external operation member (button) 65A provided on the surface of the case of the video camera 51. When the button is operated, the key input circuit 65 outputs a signal indicating a kind of the operation performed by the user to the microprocessor 66.

The microprocessor 66 executes predetermined programs to control the overall operation of the video camera 51.

For example, the microprocessor 66 determines which button is currently pressed by the user on the basis of data obtained by analog-to-digital (AD) conversion of signals supplied from the key input circuit 65 or signals supplied from a touch panel 69. Then, the microprocessor 66 sends a corresponding command to an on-screen display circuit 67 to update the screen displayed on the LCD panel 70 according to the operation performed by the user. For example, the screen is updated when a message for notifying the user of occurrence of a problem relating to the imaging function or the playback function is being displayed and a shortcut button displayed on the same screen is operated.

Furthermore, the microprocessor 66 controls the lens 61, the camera signal processing circuit 63, and the recording and playback processing circuit 64 to execute imaging, and controls the recording and playback processing circuit 64 to play back captured video signals.

The on-screen display circuit 67 interprets the command supplied from the microprocessor 66, loads bitmap data supplied together with the command in a video random access memory (VRAM), and generates display signals for displaying a screen on the LCD panel 70. The on-screen display circuit 67 outputs the display signals to the superposing circuit 68 on an individual scanning line basis.

During imaging, the superposing circuit 68 superposes the display signals supplied from the on-screen display circuit 67 on the video signals supplied from the camera signal processing circuit 63, and outputs the resulting video signals to, for example, the LCD panel 70, a viewfinder panel 71, or a LINE OUT terminal for outputting the video signals to an external apparatus, such as a television receiver. In the screen displayed at an output destination on the basis of the video signals output from the superposing circuit 68 during imaging, various buttons are displayed as superposed on the image being captured.

Furthermore, during playback of video signals, the superposing circuit 68 superposes the display signals supplied from the on-screen display circuit 67 on the video signals supplied from the recording and playback processing circuit 64, and outputs the resulting video signals.

The touch panel 69 is provided on the LCD panel 70. The touch panel 69 detects user's contact on a button in the screen displayed on the LCD panel 70, and outputs an electric signal indicating a position corresponding to the operation by the user to the microprocessor 66.

The LCD panel 70 displays a screen on the basis of the video signals supplied from the superposing circuit 68.

Similarly, the viewfinder panel 71 displays a screen on the basis of the video signals supplied from the superposing circuit 68. For example, when display on the LCD panel 70 is off, the viewfinder panel 71 allows the user to check video content being captured or video content being played back.

A power supply circuit 72 supplies power to the microprocessor 66 and other circuits. Power to the other circuits is supplied via a power supply control circuit 75 under the control of the microprocessor 66. The power is from a battery 73, or from outside via an AC cable 74. The power supply circuit 72 also outputs power supplied from outside via the AC cable 74 to the battery 73 to charge the battery 73.

FIG. 8 is a block diagram showing an example of the functional configuration of the video camera 51. At least some of the functional modules shown in FIG. 8 are implemented by execution of predetermined programs by the microprocessor 66 shown in FIG. 7.

As shown in FIG. 8, in the video camera 51, a problem occurrence detector 81 and a setting manager 82 are implemented.

The problem occurrence detector 81 monitors whether a problem has occurred regarding capturing or playback of video signals on the basis of reports from the recording and playback processing circuit 64 while captured video signals are being played back by the playback function or video signals are being captured by the imaging function.

Upon detecting occurrence of a problem, the problem occurrence detector 81 checks whether the problem can be solved by changing setting from a menu screen, for example, by checking current setting managed by the setting manager 82. If it is determined that the problem can be solved, the problem occurrence detector 81 controls the on-screen display circuit 67 so that a message notifying the user of the kind of the problem and a solution to the problem is displayed on the LCD panel 70. Together with this message, the problem occurrence detector 81 also displays a shortcut button or the like that is operated when directly changing setting to solve the problem.

On the other hand, when it is determined that the problem will not be solved by changing setting from the menu screen, the problem occurrence detector 81 displays a message notifying the user of the occurrence of the problem on the LCD panel 70.

For example, the problem occurrence detector 81 detects occurrence of a problem relating to the playback function when the HD format is selected by the user as a playback format but a segment of video signals video signals recorded in the SD format is being played back so that video content that is played back is not displayed on the LCD panel 70 and a blue background is displayed on the screen instead.

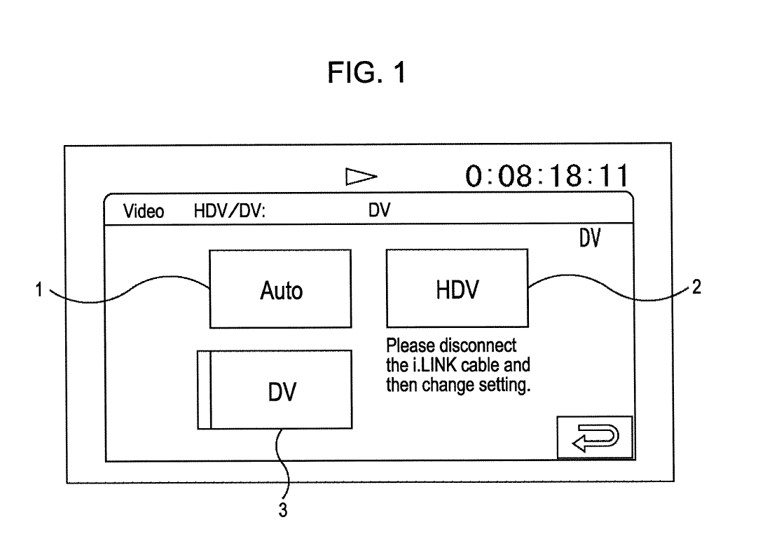

The video camera 51 shown in FIG. 7 allows recording video signals in the SD format and video signals in the HD format together on the same tape and playing back these video signals. For example, the user can record one scene in the SD format and record another scene in the HD format. The user can select a playback format in a setting screen shown in FIG. 1, which can be displayed by performing a certain operation in the menu screen.

As an example, a case will be considered where a tape having recorded thereon both video signals in the HD format and video signals in the SD format is loaded and a playback instruction is received. When “SD” is selected in the setting screen shown in FIG. 1, video content played that is back is displayed on the LCD panel 70 only while a segment of video signals recorded in the SD format is being played back. Video content that is played back is not displayed while a segment of video signals recorded in the HD format is being played back, and a blue background is displayed on the LCD panel 70.

When the recording medium is a tape, video signals are sequentially played back starting from video signals recorded at a position specified as a start point of playback according to the playback instruction. Thus, when the tape has recorded thereon both video signals in the HD format and video signals in the SD format, video signals in the HD format are played back at a certain timing, and video signals in the SD format are played back at another timing.

On the other hand, when “HD” is selected in the setting screen shown in FIG. 1, video content that is played back is displayed on the LCD panel 70 only while a segment of video signals recorded in the HD format is being played back. Video content that is played back is not displayed while a segment of video signals recorded in the SD format is being played back, and a blue background is displayed on the LCD panel 70.

When “Auto” is selected, since “Auto” is setting in which the video camera 51 automatically switches processing for playback in accordance with formats, video content that is played back is displayed appropriately on the LCD panel 70 while a segment of video signals recorded in the HD format is being played back and while a segment of video signals recorded in the SD format is being played back.

Furthermore, when the brightness of video content currently being captured is not appropriate due to a user's manual operation for reducing brightness, the problem occurrence detector 81 detects occurrence of a problem relating to the imaging function. The video camera 51 allows the user to manually adjust the brightness of video content being captured.

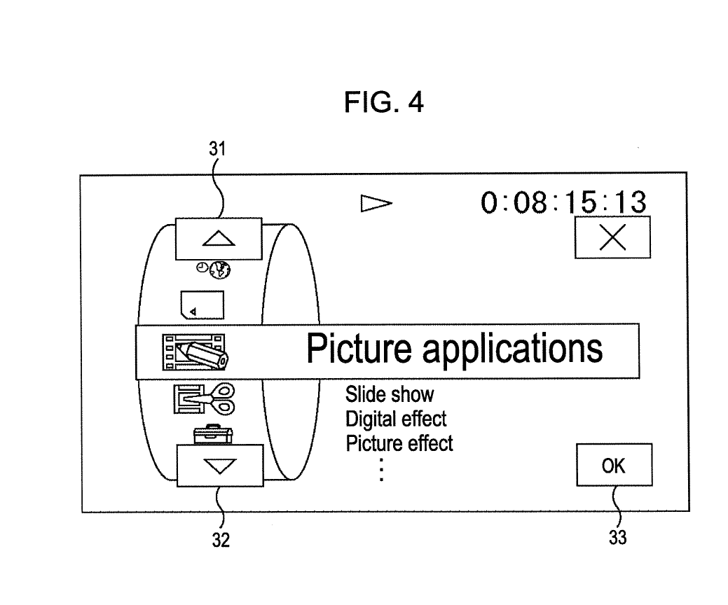

The setting manager 82 shown in FIG. 8 manages current setting regarding the imaging function and current setting regarding the playback function for playing back captured video signals. These settings are entered in the setting screen shown in FIG. 1, which can be opened from the menu screen shown in FIG. 4. The menu screen shows names of various functions, and when one of the functions has been selected, a setting screen for the selecting function is displayed on the LCD panel 70 instead of the menu screen.

Furthermore, upon detecting on the basis of a signal supplied from the touch panel 69 that the user has pressed a shortcut button that is displayed by the problem occurrence detector 81 when a problem has occurred and that allows directly changing setting to solve the problem, the setting manager 82 changes setting to solve the problem and manages the setting that has been changed.

Next, a process executed by the video camera 51 configured as described above will be described with reference to a flowchart shown in FIG. 9.

The following description deals with a process that is executed in a case where video content that is played back is not displayed because video signals in a format different from a playback format selected by the user are being played back so that a blue background is displayed on the LCD panel 70, as described earlier.

This process is started, for example, when a playback button displayed on the LCD panel 70 is pressed and a signal indicating pressing of the playback button is output from the touch panel 69 to the microprocessor 66. The microprocessor 66 generates a control signal that instructs start of playback of video signals recorded on the tape, and outputs the control signal to the recording and playback processing circuit 64. After the start of playback, video signals obtained by the recording and playback processing circuit 64 are supplied to the superposing circuit 68 so that corresponding video content is displayed on the LCD panel 70, and the recording and playback processing circuit 64 notifies the microprocessor 66 of a status of playback.

In step S1, if the problem occurrence detector 81 has determined that a blue background is displayed on the LCD panel 70 on the basis of a notification from the recording and playback processing circuit 64, the problem occurrence detector 81 detects that a problem relating to the playback function has occurred. In this case, the recording and playback processing circuit 64 outputs to the microprocessor 66 a problem signal indicating that a blue background is displayed on the LCD panel 70.

For example, in a case where “HD” for playing back only video signals in the HD format is selected in the setting screen shown in FIG. 1, the problem occurrence detector 81 detects occurrence of a problem if video signals that are being played back are video signals in the SD format.

In step S2, the problem occurrence detector 81 analyzes problem information supplied from the recording and playback processing circuit 64 to check whether the problem that has occurred is a problem that can be solved by changing setting in the setting screen.

If it is determined in step S2 that that the problem is not a problem that can be solved by changing setting, in step S3, the problem occurrence detector 81 outputs a command to the on-screen display circuit 67 so that a message for notifying the user of the kind of the problem is displayed on the LCD panel 70 or the view finder panel 71 via the superposing circuit 68.

The process is then exited. After checking the message, the user displays the menu screen, then displays the setting screen shown in FIG. 1, which can be opened by operating one of the various buttons in the menu screen, and changes setting in the setting screen.

On the other hand, when it is determined in step S2 that the problem is a problem that can be solved by changing setting, in step S4, the problem occurrence detector 81 displays on the LCD panel 70 or the view finder panel 71 a message for notifying the user of the kind of the problem, such as the name of the function relevant to the problem, and a solution to the problem.

For example, if a problem that a blue background is displayed on the LCD panel 70 has been detected, the problem can be solved by appropriate setting of the playback format. Thus, it is determined that the problem is a problem that can be solved by changing setting, so that a message for notifying the user of the kind of the problem and a solution to the problem is displayed.

Furthermore, in step S5, in a popup showing the message, the problem occurrence detector 81 displays a setting changing button and a closing button. The setting changing button is a shortcut button that is operated when directly changing setting to solve the problem. The closing button is operated when closing the displayed message.

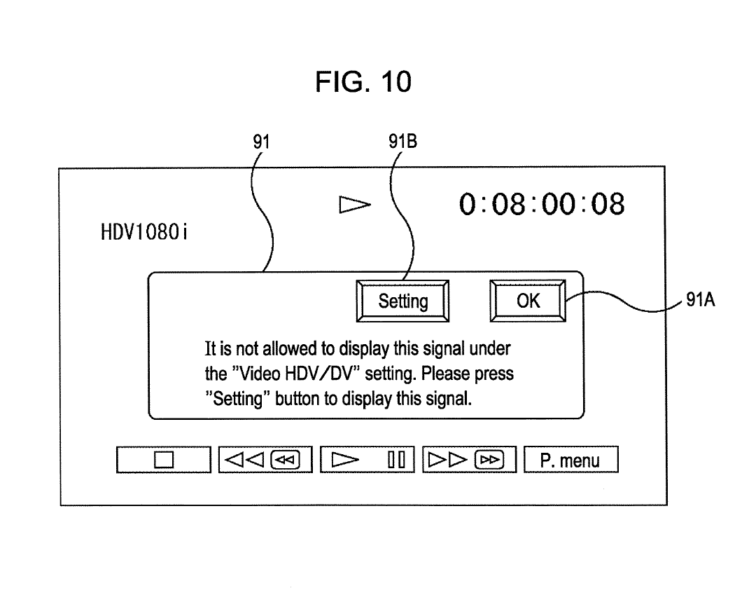

FIG. 10 is a diagram showing an example of a screen displayed on the LCD panel 70.

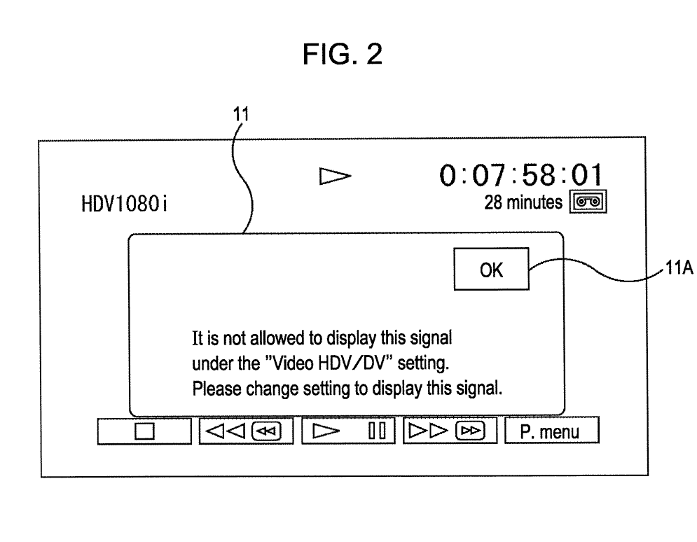

Basically, the screen shown in FIG. 10 differs from the screen shown in FIG. 2 in that the content of the message differs partially and in that a setting changing button 91B is further displayed on the left side of a closing button 91A that is operated when closing the displayed message. The setting changing button 91B is a shortcut button that is operated when directly changing setting to solve the problem without displaying a setting screen or the like.

In the example shown in FIG. 10, a popup 91 is displayed substantially at the center of the screen, in which a message saying “It is not allowed to display this signal under the Video HDV/DV setting. Please press ‘Setting’ button to display this signal.” is displayed. The message is displayed as superposed on the blue background, i.e., with the problem unsolved.

On the message, the closing button 91A and the setting changing button 91B are displayed. The message shown in the popup 91 indicates that the problem is associated with the setting of “Video HDV/DV”, and prompts the user to press the setting changing button 91B, displayed together with the message, to display video content that is played back.

The user can close the displayed message by pressing the closing button 91A. Furthermore, by pressing the setting changing button 91B, the user can change setting to solve the problem that a blue background is displayed on the LCD panel 70.

Referring back to FIG. 9, in step S6, the setting manager 82 determines which of the setting changing button 91B and the closing button 91A has been pressed, on the basis of a signal supplied from the touch panel 69.

If it is determined in step S6 that the closing button 91A has been pressed, the setting manager 82 closes the displayed message, and the process is then exited. The closing button 91A is provided for cases where the user does not wish to change the current setting.

On the other hand, if it is determined in step S6 that the setting changing button 91B has been pressed, in step S7, the setting manager 82 changes setting and manages the setting that has been changed.

In step S8, the setting manager 82 displays on the LCD panel 70 or the view finder panel 71 a message for notifying the user of the setting that has been changed.

For example, if the setting changing button 91B has been pressed, the setting manager 82 changes the setting of the playback format to “Auto”, with which video signals in the SD format can be played back. Furthermore, the setting manager 82 outputs to the recording and playback processing circuit 64 a control signal that instructs playback of video signals with the “Auto” setting, and displays on the LCD panel 70 or the like a message for notifying the user that the setting has been changed to “Auto”. The recording and playback processing circuit 64 switches playback processing so that playback processing for the SD format is executed.

At this time, since the setting of the playback format matches the format of the actual recorded video signals (i.e., the SD format, which is the format of the video signals that are played back, is one of the formats of video signals that can be played back with the “Auto” setting), video content that is played back is displayed appropriately on the LCD panel 70, so that the problem is solved. The process is then exited.

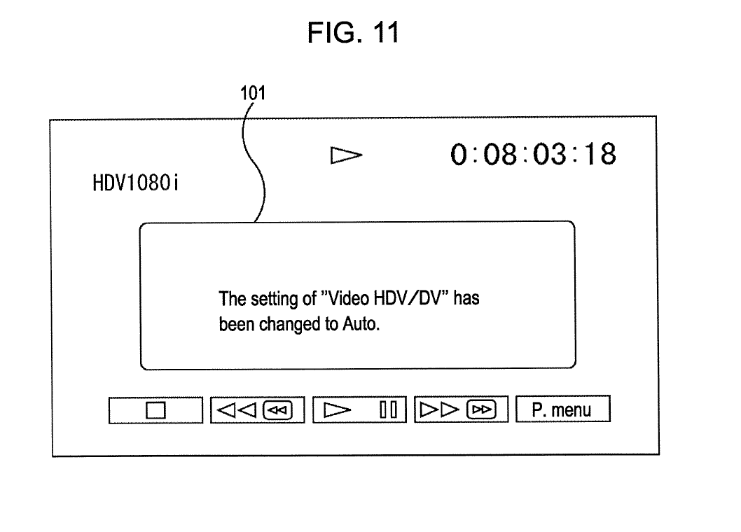

FIG. 11 is a diagram showing an example of a screen that is displayed on the LCD panel 70 immediately after the setting changing button 91B shown in FIG. 10 is pressed.

In the example shown in FIG. 11, a popup 101 is displayed, and a message saying “The setting of Video ‘HDV/DV’ has been changed to Auto.” is displayed in the popup 101.

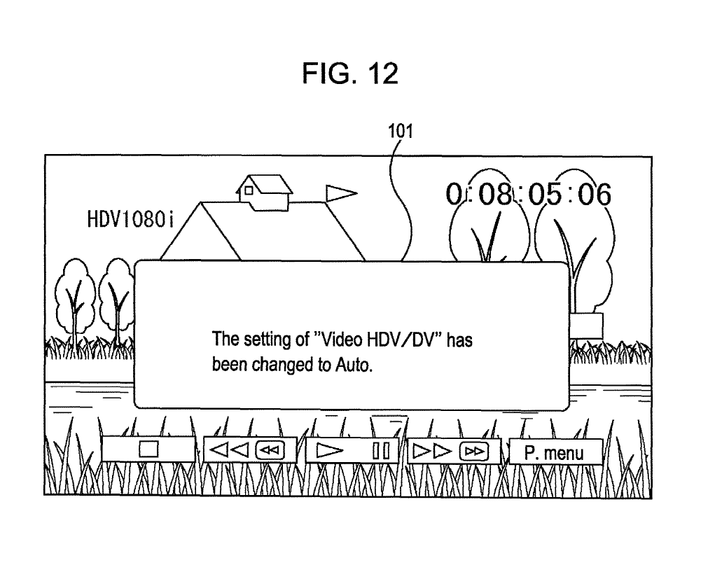

FIG. 12 is a diagram showing an example of a screen that is displayed on the LCD panel 70 subsequently to the screen shown in FIG. 11.

When the change of setting has taken effect and playback by the recording and playback processing circuit 64 has been started with “Auto” as setting of the playback format, playback processing for video signals to be played back is executed in accordance with the SD format, so that video content that is played back is displayed appropriately.

In the example shown in FIG. 12, video content that is played back is displayed in the background of the popup 101. The popup 101 is closed after elapse of a predetermined period, so that the user can view the video content that is played back.

Through the process described above, the user can readily and quickly change setting to solve the problem by pressing a button that is displayed together with a message for notifying the user of the kind of the problem or the like.

Furthermore, by quickly solving the problem, the user is prevented from missing opportunities while being troubled with the problem. Furthermore, the user can use the video camera 51 comfortably without worrying.

The above description deals with a case where a problem relating to setting of the playback format exists. Problems relating to other types of setting can also be solved in similar manners.

For example, if the user manually sets the brightness of video content but it is detected during imaging that the brightness is not appropriate, the problem occurrence detector 81 detects occurrence of a problem relating to the imaging function. In this case, a message indicating that the brightness is not appropriate is displayed together with a shortcut button that is operated when directly changing setting so that the brightness will be appropriate.

When the shortcut button is pressed, setting is changed so that the brightness of video signals that are captured will be appropriate. Furthermore, the user is notified that the setting of the brightness has been changed.

As another example, a problem relating to the playback function may be detected when the aspect ratio of video content that is played back differs from the aspect ratio of the LCD panel 70, and a problem relating to the imaging function may be detected when focus is not adjusted appropriately.

In the example described above, setting is directly changed without displaying a setting screen when a shortcut button that is displayed together with a message indicating occurrence of a problem is pressed. Alternatively, however, if the setting involves complex items, a special screen for changing setting may be displayed instead of a screen that has been displayed so that the user can change setting in the screen.

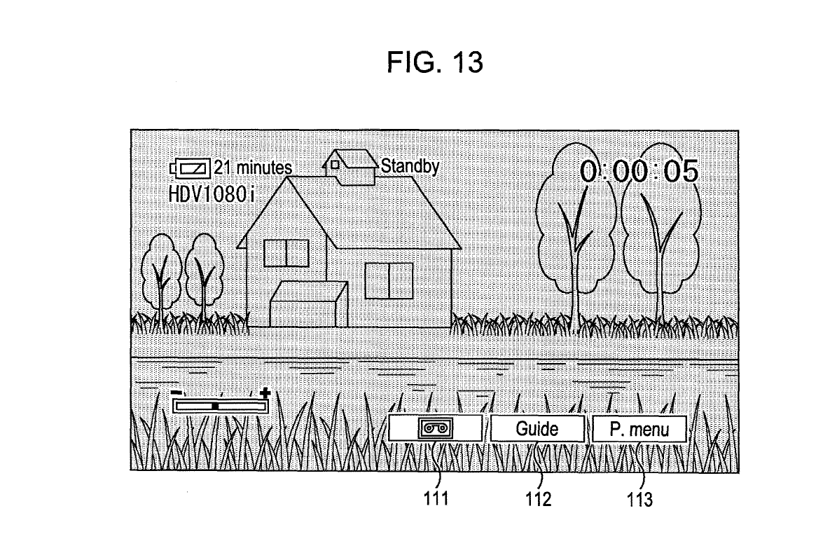

Examples where a special screen for changing setting is displayed in response to pressing of a shortcut button instead of a screen that has been displayed will be described with reference to FIGS. 13 to 17.

FIG. 13 is a diagram showing an example of a screen displayed on the LCD panel 70, displaying video content that is being captured.

In this example, the brightness manually set by the user is not appropriate so that video content that is being captured is dark. Below the screen, a button 111 that is operated when displaying information of a tape, a button 112 that is operated when displaying guidance of operation procedures, and a button 113 that is operated when displaying a menu screen are arrayed.

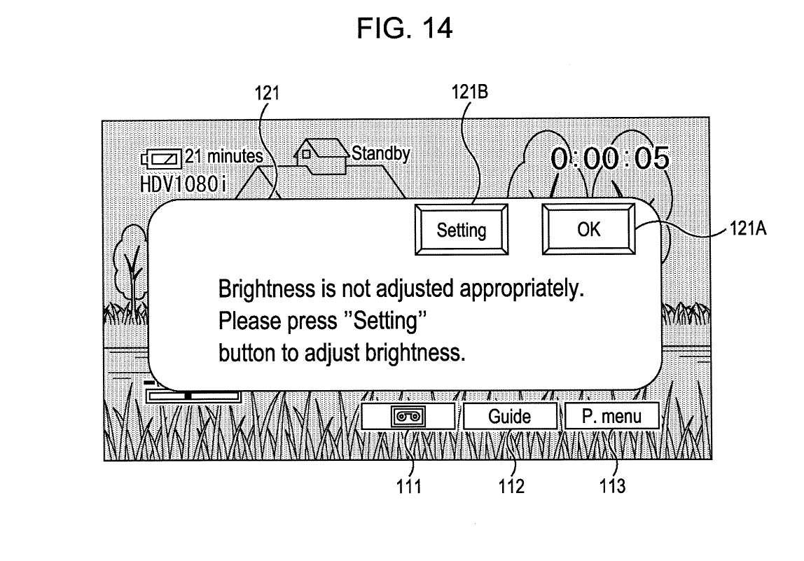

In this case, for example, the brightness of video content that is being captured, reported from the recording and playback processing circuit 64, is compared with an appropriate brightness, and the problem occurrence detector 81 detects a problem relating to setting of brightness if the comparison results in a mismatch. At this time, a screen shown in FIG. 14 is displayed on the LCD panel 70.

In the example shown in FIG. 14, a popup 121 is displayed, and a message saying “Brightness is not adjusted appropriately. Please press ‘Setting’ button to adjust brightness.” is displayed in the popup 121. The message is displayed as superposed on the dark video content, i.e., with the problem unsolved.

On the message, a closing button 121A and a setting changing button 121B are displayed. The message displayed in the popup 121 indicates that a problem exists relating to adjustment of brightness and that the setting of brightness can be changed by pressing the setting changing button 121B displayed together with the message.

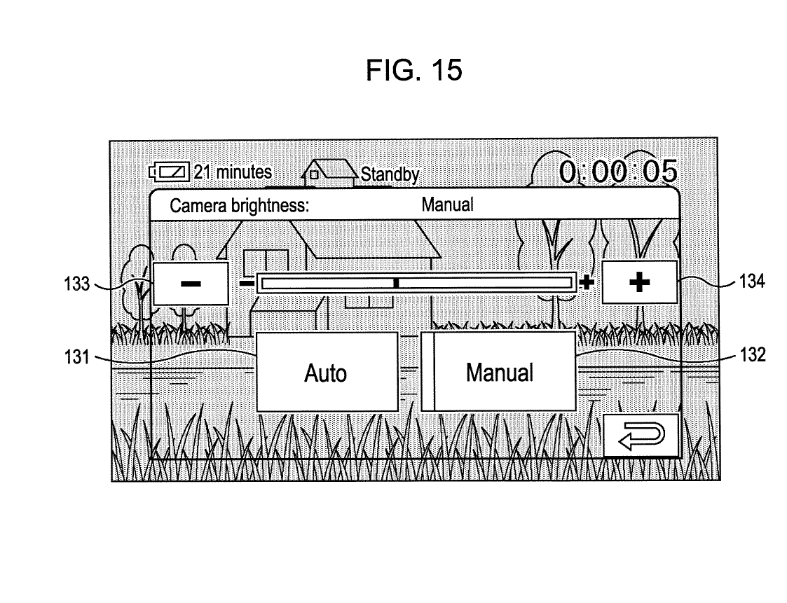

When the setting changing button 121B shown in FIG. 14 has been pressed, a special screen for adjusting brightness, shown in FIG. 15, is displayed on the LCD panel 70.

In the example shown in FIG. 15, a button 131 that is operated when selecting the “Auto” setting for automatically adjusting brightness by the video camera 51, and a button 132 that is operated when selecting the “Manual” setting for manually adjusting brightness by the user are displayed.

When the “Manual” setting is selected, the user can manually adjust brightness by pressing a minus button 133 and a plus button 134 that are displayed above the buttons 131 and 132.

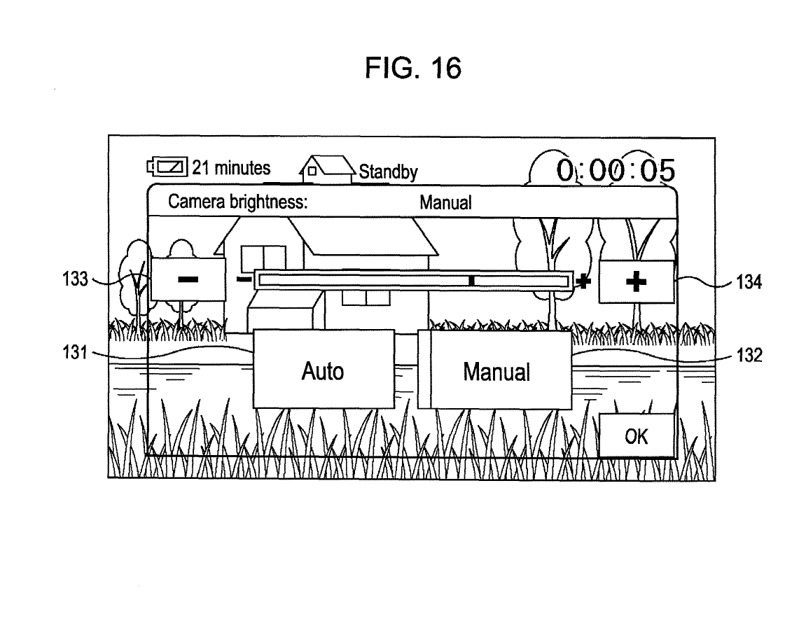

When the button 131 is pressed to select “Auto” so that the brightness of video content is automatically adjusted to an appropriate brightness, or when “Manual” is selected and the minus button 133 or the plus button 134 is operated so that the brightness of video content is adjusted to an appropriate brightness by the user, video content is displayed on the screen as shown in FIG. 16.

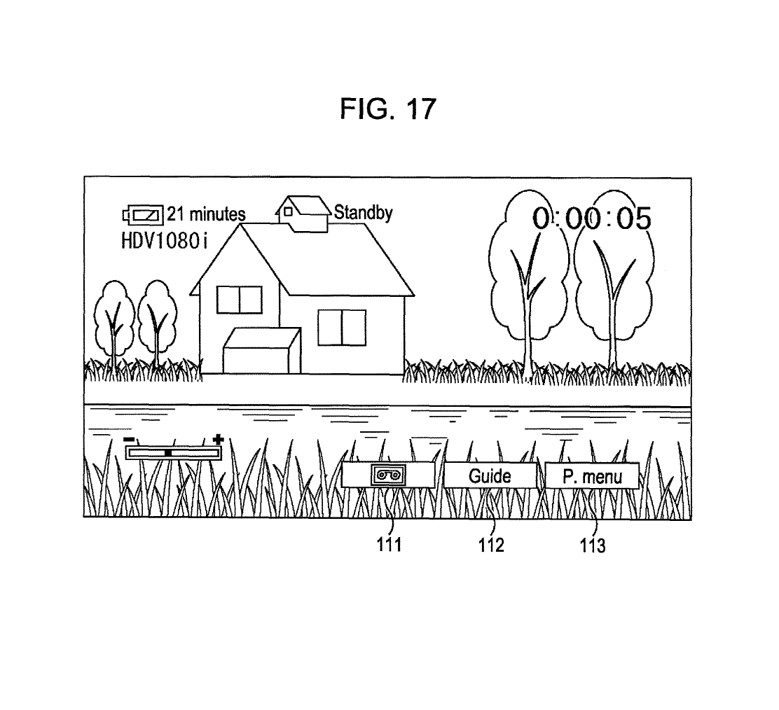

In the screen shown in FIG. 16, the video content that is displayed as a background of various buttons is brighter than the video content displayed as a background of the screen shown in FIG. 15, and has an appropriate brightness. After elapse of a predetermined period, the buttons used for adjusting brightness disappear, so that a screen shown in FIG. 17 is displayed. Thus, the user can view video content having an appropriate brightness.

As described above, by displaying a setting screen when a button displayed with a message is operated, the user can also change setting readily and quickly using the displayed setting screen.

Although the above description has been given in the context of cases where a tape is used as a recording medium in the video camera 51, other types of recording medium may be used instead of a tape, such as an optical disc, a hard disc, or a flash memory.

Furthermore, although the above description has been given in the context of cases where a message indicating a kind of a problem is displayed upon occurrence of the problem, alternatively, the user may be allowed to select whether such a message is displayed upon occurrence of a problem.

The message might be annoying to a user who has got used to operation of the video camera 51 and can change setting by themselves by opening a setting screen from a menu screen or the like. It is convenient for such a user that the user is allowed to select whether to display the message. In this case, a message is displayed upon detection of occurrence of a problem when the message displaying function is ON, while no message is displayed even if occurrence of a problem is detected when the message displaying function is OFF.

Furthermore, although the above description has been given in the context of cases where setting is changed or a setting screen is displayed in response to pressing of a button displayed together with a message, i.e., cases where a problem is solved interactively, alternatively, setting may be changed automatically upon detection of occurrence of a problem without notifying the user so that the user is only notified of the setting change.

Thus, the user can use the video camera 51 more comfortably without being bothered.

Furthermore, a user who has not used to operation of the video camera 51 might feel uneasiness with the difficulty of deciding whether to change setting even if the user views the message, so that it is advantageous to automatically change setting to prevent the user from feeling such uneasiness.

Furthermore, the user may be allowed to select using a setting screen whether a message is to be displayed so that setting can be changed interactively or setting is to be changed automatically without displaying a message.

The series of processes described above can be executed either by hardware or by software. When the series of processes is executed by software, a program constituting the software is installed from a program recording medium.

The program executed by a computer may included steps that are executed sequentially in the orders described herein, steps that are executed in parallel, or steps that are executed when called or other suitable timings.

It should be understood by those skilled in the art that various modifications, combinations, sub-combinations and alterations may occur depending on design requirements and other factors insofar as they are within the scope of the appended claims or the equivalents thereof.

What is claimed is:

1. An imaging device at least having an imaging function and a playback function of playing back captured video signals, the imaging device comprising:
display controlling means for detecting occurrence of a problem relating to the imaging function or the playback function, and displaying a button together with a message indicating a kind of the problem when the problem detected is a problem solvable by changing setting, the button being a button that is operated when changing setting to solve the problem; and
setting means for changing setting according to an operation of the button displayed by the display controlling means.

2. The imaging device according to claim 1, wherein the display controlling means displays the message as superposed on a screen exhibiting occurrence of the problem.

3. The imaging device according to claim 1, wherein the display controlling means further displays a message indicating an operation for solving the problem.

4. A setting method for an imaging device at least having an imaging function and a playback function of playing back captured video signals, the setting method comprising the steps of:
detecting occurrence of a problem relating to the imaging function or the playback function, and displaying a button together with a message indicating a kind of the problem when the problem detected is a problem solvable by changing setting, the button being a button that is operated when changing setting to solve the problem; and
changing setting according to an operation of the displayed button.

5. A program for causing a computer to execute processing for setting of an imaging device at least having an imaging function and a playback function of playing back captured video signals, the program comprising the steps of:
detecting occurrence of a problem relating to the imaging function or the playback function, and displaying a button together with a message indicating a kind of the problem when the problem detected is a problem solvable by changing setting, the button being a button that is operated when changing setting to solve the problem; and
changing setting according to an operation of the displayed button.

6. An imaging device at least having an imaging function and a playback function of playing back captured video signals, the imaging device comprising:
display controlling means for detecting occurrence of a problem relating to the imaging function or the playback function, displaying a button together with a message indicating a kind of the problem when the problem detected is a problem solvable by changing setting, the button being a button that is operated when displaying a setting screen used for changing setting, and displaying the setting screen in response to an operation of the button in place of a screen displaying the message; and
setting means for changing setting according to an operation performed using the setting screen displayed by the display controlling means.

7. A setting method for an imaging device at least having an imaging function and a playback function of playing back captured video signals, the setting method comprising the steps of:
detecting occurrence of a problem relating to the imaging function or the playback function, displaying a button together with a message indicating a kind of the problem when the problem detected is a problem solvable by changing setting, the button being a button that is operated when displaying a setting screen used for changing setting, and displaying the setting screen in response to an operation of the button in place of a screen displaying the message; and
changing setting according to an operation performed using the displayed setting screen.

8. A program for causing a computer to execute processing for setting of an imaging device at least having an imaging function and a playback function of playing back captured video signals, the program comprising the steps of:
detecting occurrence of a problem relating to the imaging function or the playback function, displaying a button together with a message indicating a kind of the problem when the problem detected is a problem solvable by changing setting, the button being a button that is operated when displaying a setting screen used for changing setting, and displaying the setting screen in response to an operation of the button in place of a screen displaying the message; and
changing setting according to an operation performed using the displayed setting screen.

9. An imaging device at least having an imaging function and a playback function of playing back captured video signals, the imaging device comprising:
a display controller configured to detect occurrence of a problem relating to the imaging function or the playback function, and to display a button together with a message indicating a kind of the problem when the problem detected is a problem solvable by changing setting, the button being a button that is operated when changing setting to solve the problem; and
a setting unit configured to change setting according to an operation of the button displayed by the display controller.

10. An imaging device at least having an imaging function and a playback function of playing back captured video signals, the imaging device comprising:
a display controller configured to detect occurrence of a problem relating to the imaging function or the playback function, to display a button together with a message indicating a kind of the problem when the problem detected is a problem solvable by changing setting, the button being a button that is operated when displaying a setting screen used for changing setting, and to display the setting screen in response to an operation of the button in place of a screen displaying the message; and
a setting unit configured to change setting according
to an operation performed using the setting screen displayed by the display controller.
